(19) United States
(12) Patent Application Publication
(10) Pub. No.: US 2009/0064544 A1
(43) Pub. Date: Mar. 12, 2009

(54) EXCAVATION APPARATUS AND METHOD

(76) Inventor: Robert C. Rajewski, Stettler (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/963,703

(22) Filed: Dec. 21, 2007

(30) Foreign Application Priority Data
Sep. 7, 2007 (CA) 2601608

(51) Int. Cl. E02F 3/96; E02F 3/88; E02F 1/00; A01B 79/00

(52) U.S. Cl. 37/403; 172/1; 37/195; 137/899.4

(57) ABSTRACT

An excavation apparatus is provided having a loader, a tank, a vacuum pump and a vacuum hose. The loader has an engine and is mounted on either tracks or wheels, with the tank attached on the loader. Both of the vacuum pump and vacuum hose are in fluid connection with the tank. The vacuum hose draws excavated material into the tank, which draws its suction from the vacuum pump. The tank can easily dump its contents when full, and resume drawing in excavated material. The excavation apparatus can be easily transported to the job site using transport equipment the operation of which requires only basic licenses. The loader may be a bobcat. This system may be used in tandem with a hydro excavation system.

### TECHNICAL FIELD

The apparatus and method relate to excavation devices.

### BACKGROUND

Hydrovac trucks are impractical at many types of jobsites, due to their large size, limited maneuverability, and operational complexity. Additionally, traditional hydrovac trucks are limited by their capacity for carrying water and storing excavated materials.

### SUMMARY

An excavation apparatus is provided comprising a loader, a tank, a vacuum pump and a vacuum hose. The loader is mounted on either tracks or wheels, with the tank carried by the loader. The vacuum pump and vacuum hose are in fluid connection with the tank. When the vacuum pump is activated, the vacuum hose draws excavated material into the tank. An operator can easily dump the contents of the tank, and resume drawing in excavated material. The excavation apparatus can be easily transported to the job site using transport equipment the operation of which requires only basic licenses. This excavation apparatus is designed to work on the most difficult terrain, under the most treacherous conditions, in small and hard to reach areas, without skilled personnel, and for less cost than a conventional hydrovac truck. Methods of earth working and excavation are also provided.

### BRIEF DESCRIPTION OF THE FIGURES

Embodiments will now be described with reference to the figures, in which like reference characters denote like elements, by way of example, and in which:

FIG. 1 is a side elevation view of an embodiment of a front-end loader carrying a vacuum pump, pulling a trailer carrying a water tank, and vacuuming up solids and water excavated from a trench into a tank;

FIG. 2 is a side elevation view, partially in section, of the front-end loader of FIG. 1 removing water from the tank;

FIG. 3 is a side elevation view of the front-end loader of FIG. 1 dumping the contents of the tank into a container;

FIG. 4 is a side elevation view of a container filled by the front-end loader of FIG. 1 dumping its contents;

FIG. 5 is a side elevation view of the front-end loader of FIG. 1 dumping the contents of the tank;

FIG. 6 is side elevation view of a front-end loader carrying a water tank, pulling a trailer carrying a vacuum pump, and excavating a trench;

FIG. 7 is a flow-diagram of a method of vacuuming up and dumping a slurry of solids and water using a loader;

FIG. 8 is a flow-diagram of a method of vacuuming up and dumping a slurry of solids and water into a container using a loader;

FIG. 9 is a flow-diagram of a method of excavating and refilling a trench;

FIG. 10 is a flow-diagram of a method of vacuuming up a slurry of solids and water, dumping the slurry into a container, removing water from the slurry and dumping the solids from the container;

FIG. 11 is a flow-diagram of a method of transporting a hydro-excavation apparatus and carrying out a hydro-excavation at a jobsite;

FIG. 12 is a perspective view of a wire basket container filled with excavated materials;

FIG. 13 is a side elevation view of a cloth liner filled with excavated materials being dumped into a hole or trench;

FIG. 14 is a side elevation view, partially in section, of a further embodiment of a front-end loader;

FIG. 15 is a top plan view of the tank design from FIG. 14; and

FIG. 16 is a side elevation view, partially in section, of the tank design from FIG. 14 in the open position.

### DETAILED DESCRIPTION

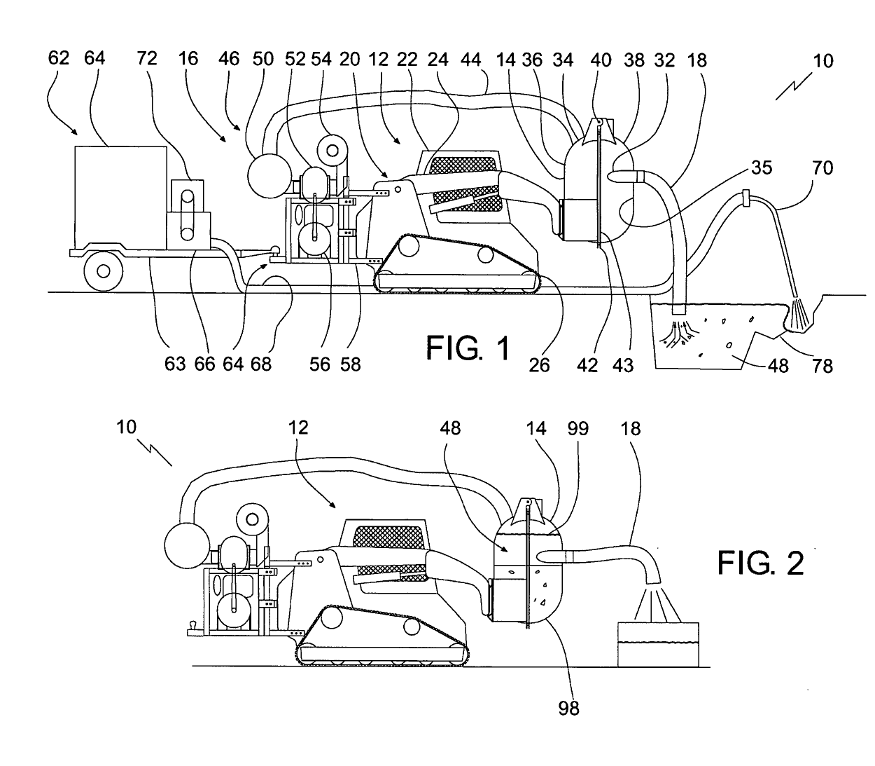

Referring to FIG. 1, an exemplary excavation apparatus 10 includes a loader 12, a tank 14, a vacuum pump 16, and a vacuum hose 18. Loader 12 has an engine 20, a cab 22, and a lifting arm 24. The lifting arm 24 may be originally built with the loader or added and provides a lifting function (movement vertically) such as by manipulation of the arm 24 about horizontal pivot 21 by using an actuator such as a hydraulic cylinder 23, and may also be provided with extension capabilities as for example using telescoping components.

Loader 12 may for example be based on a type of loader known as a Bobcat™ loader. Other types of machinery may be used as loader 12. Examples of suitable loaders 12 may be an ASV Positrack vehicle such as model RC-100, a skid steer loader such as a TCM Skid Steer loader or a loader such as a model no. 297C loader made by Caterpillar or a wheeled loader made by Caterpillar. Loader 12 may be any suitable type of all-terrain vehicle or tractor equipped with a loading arm. Loader 12 may also be a front-end loader as shown, or any other type of loader 12 known in the art of loaders. In an embodiment, loader 12 has a turning radius less than its own length, where the length does not include the loading arm. Hence, in various embodiments, the loader 12 may have a turning radius of less than 3 meters or less than 2.5 meters or less than 2 meters or less than 1.5 meters or less than 1 meter. The turning radius is the radius of the smallest circle within which the loader can turn 360 degrees, where the loader does not include the loading arm. It is also desirable that the minimum operational radius be small, for example less than 3 meters or less than 2.5 meters or less than 2 meters or less than 1.5 meters or less than 1 meter. The minimum operational radius is the radius of the smallest circle in which the loader 12 including loading arm and any attachments used during operation can turn 360 degrees. The loader 12 may for example be based on a loader that was built with or built to be capable of handling a 0.5 cubic meters to 4 cubic meters capacity loading bucket and that has been modified to remove or modify the bucket and replace it with a tank to hold vacuumed materials.

In an embodiment, loader 12 may operate with a tracked or wheeled system that allows the loader 12 to turn 360 degrees around an axis passing vertically through loader 12, as for example an axis passing centrally through the loader. By having a turn-in-own-length function, loader 12 is able to maneuver skillfully through treacherous jobsites. Loader 12 in various embodiments is designed to be compact, short, and lightweight. A loader 12 with a shorter height than a typical hydrovac truck can fit into small areas, such as parking garages. For example, a tracked loader provides the turn-in-own-length function by using independently operable tracks. Thus, in one embodiment, loader 12 is mounted on individually reversible tracks 26, as shown in FIG. 1. Referring to FIG. 6, loader 12 may be mounted on wheels 28. The wheels 28 may be individually reversible as in a skid steer loader. Tracks 26 in some applications are preferred over wheels 28, since tracks 26 give loader 12 the ability to traverse the most treacherous jobsite conditions. Tracks 26 also give a smoother ride than wheels 28. Referring to FIG. 1, cab 22 has space for only a single person, although in some embodiments a larger loader 12 may be used as part of this apparatus having space for additional people.

Referring to FIG. 1, tank 14 is attached to lifting arm 24 of loader 12. In an embodiment, lifting arm 24 attaches to tank 14 at the bottom of tank 14, in order to allow the door of loader 12 to open when lifting arm 24 is lowered. Tank 14 may be attached to lifting arm 24 at any point on tank 14. Tank 14 may be attached to any part of loader 12, including an additional lifting arm (not shown) mounted on the loader. Exemplary tank 14 has an excavation inlet 32, a vacuum outlet 34, a first segment 36, a second segment 38, a hinge 40, sealing lips 42, and a mud skirt 43. In an embodiment, tank 14 has a clamshell configuration. Tank 14 also has a containing wall 35. In the embodiment of FIG. 1, first and second segments 36 and 38, respectively, define containing wall 35. Containing wall 35 may include, for example, the inner tank walls of the top, bottom, or sides. At least a portion of containing wall 35 defines a dump door. In the embodiment of FIG. 1, first and second segments 36 and 38, respectively, define the dump door. In other embodiments, the portion defining the dump door may be any portion that is hinged, slideable or removable. An example of a hinged portion includes a swing door. Examples of slideable and removable portions, respectively, include a sliding door and a threaded cover, respectively. In some embodiments, tank 14 is hingedly attached to lifting arm 24 for dumping. In this embodiment, the dump door may be located at or near the top of tank 14 and may be opened prior to dumping. Hydraulic mechanisms may then rotate and dump the contents of tank 14 like a bucket.

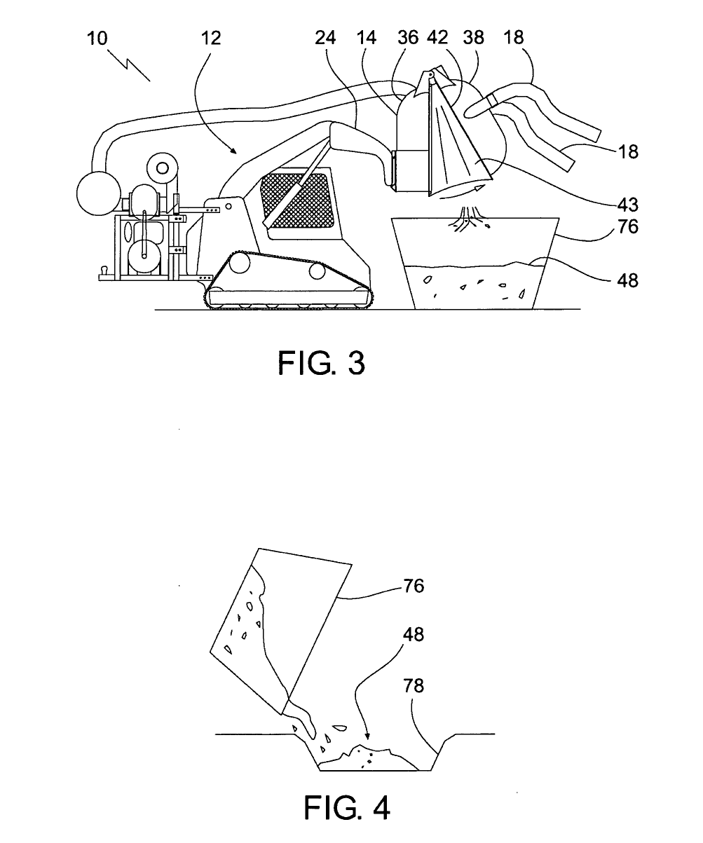

First and second segments 36 and 38, respectively, are rotatably connected by hinge 40. The segments 36, 38 rotate about an axis defined by the hinge. First and second segments 36 and 38 are movable between an open position as shown in FIG. 3, and a closed position as shown in FIG. 1. Tank 14 can be opened, closed, and locked using hydraulic mechanisms. These hydraulic mechanisms may be mounted inside or outside tank 14. Referring to FIG. 3, when tank 14 is in the open position, any contents contained within tank 14 may be dumped out. Tank 14 may be provided as any type of container that material can be vacuumed into, retained, and later removed from. An example of this may be a container with a valve or a hydraulic door located at the bottom for removing material from within the container. Tank 14 can be mechanically or hydraulically opened or closed by loader 14. Sealing lips 42 ensure that first and second segments 36 and 38, respectively, provided a sealed compartment for materials to be drawn into. Referring to FIG. 3, mud skirt 43 ensures that any excavated material contained within tank 14 does not spray out the sides of tank 14 when tank 14 is dumping its contents. Tank 14 in one embodiment as shown is a clam-shell tank design.

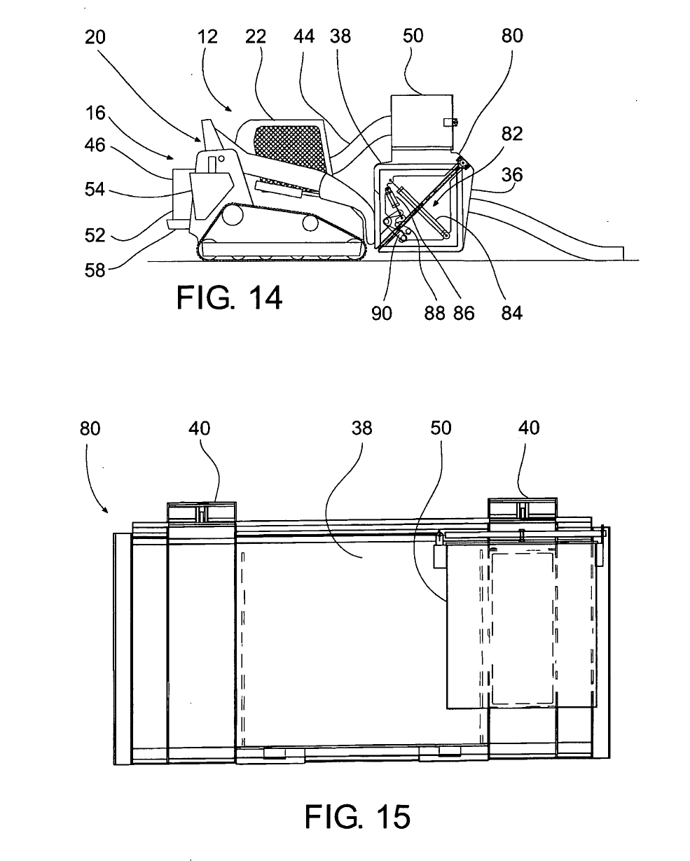

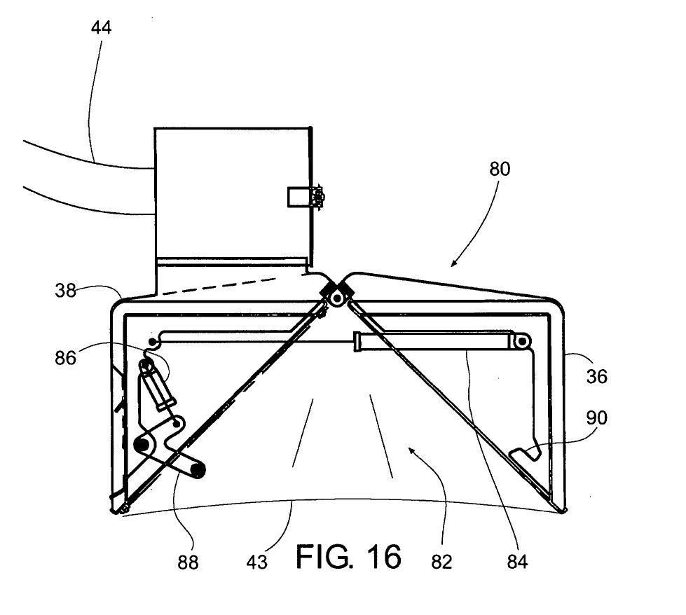

Referring to FIGS. 14-16, another design of a tank 80 is shown as a rectangular box cylinder. Tank 80 functions similarly to tank 14, although it is positioned horizontally for a lower center of gravity and opens widthwise to afford easier access to clean the insides of tank 80 after dumping. Referring to FIG. 14, tank 80 has interior hydraulics 82 comprising a door piston 84 and a locking piston 86. Referring to FIGS. 14 and 16, door piston 84 opens and closes tank 80. Locking piston 86 controls a latch 88 that engages a shoulder 90 to lock and seal tank 80. Various designs for hydraulics 82 are possible, including those that may have the opening/closing and locking mechanisms outside tank 80.

Referring to FIG. 15, tank 80 has at least two hinges 40 for providing an axis of rotation for second segment 38 about first segment 36 (shown in FIG. 16). Tank 80 also has a clamshell configuration. Referring to FIG. 16, mud skirt 43 is provided. Referring to FIGS. 1, 6, and 16, mud skirt 43 may be constructed from flexible materials. Mud skirt 43 may for example be a metal skirt assembly.

Referring to FIG. 1, vacuum outlet 34 and excavation inlet 32 are attached to first and second segments 36 and 38, respectively. Inlet 32 and outlet 34 may be attached to either of first or second segments 36 and 38, respectively. Vacuum hose 18 attaches to inlet 32, fluidly connecting vacuum hose 18 to tank 14. Vacuum hose 18 is used as an excavation conduit for drawing material through vacuum hose 18 into tank 14. Tank 14 may be provided with additional vacuum hoses 18, as needed. For example, two vacuum hoses 18 could be used, one on each side of tank 14. This dual inlet design would allow loader 12 to vacuum up excavated materials positioned on either the left or right side of loader 12 without having to re-orient loader 12. This type of dual inlet configuration is shown in FIG. 3. Additionally, if extra power was required, all but one of the available vacuum hoses 18 could be closed off, affording the one remaining vacuum hose 18 greater suction. Referring to FIG. 2, vacuum hose 18 may be used to drain water or fluids that have separated from settled solids in tank 14. A valve or valves (not shown) may be used to drain or remove fluids from tank 14. Fluids may also be removed by decanting from tank 14. This may be accomplished with the aid of a dirt screen.

Referring to FIG. 1, vacuum pump 16 attaches to outlet 34 via a vacuum conduit 44, fluidly connecting vacuum pump 16 to tank 14. Vacuum outlet 34 may be positioned above excavation inlet 32, in order to reduce the chance that materials drawn into tank 14 from inlet 32 will be drawn into outlet 34. Vacuum pump 16 may be provided as an air vacuum pump 16. Vacuum pump 16 may be reversible, making it useful for increasing or reducing pressure in tank 14. Vacuum pump 16 provides suction to draw material through vacuum hose 18 into tank 14, where the materials are thus confined to tank 14. A screen or filter (not shown) may be provided at outlet 34, in order to prevent material drawn into tank 14 by vacuum pump 16 from entering vacuum conduit 44. Referring to FIG. 1, the materials drawn into tank 14 may be a slurry of solids and water 48 created during a hydro-excavation. The slurry 48 may also be a mixture of water and earth. Additionally, air is drawn into tank 14 through vacuum hose 18 along with slurry 48.

Referring to FIG. 1, an exemplary vacuum pump 16 may comprise a filter housing 50, a blower 52, a muffler 54, and a motor 56. Filter housing 50 is provided to prevent any large particles from being drawn into blower 52. Filter housing 50 is shown positioned at the rear of blower 52 in the example shown in FIG. 1. Referring to FIG. 14, filter housing 50 is shown mounted on top of tank 80. This configuration is preferred because the air filter contained within filter housing 50 is more accessible. The air filter may clog up and require cleaning at points during operation, and because the air filter may contain a large amount of water, it may be quite heavy and awkward when it needs to be cleaned or removed. Thus it is preferred to locate it in a position where it may be easily and safely removed. FIGS. 1 and 14 show two different configurations of muffler 54. Referring to FIG. 1, muffler 54 is positioned above blower 52. Referring to FIG. 14, muffler 54 may be attached to the sides of loader 12 to reduce bulk. Alternative configurations of muffler 54 are possible, but ones that provide a more compact design are preferred. Referring to FIG. 1, motor 56 is operably connected to vacuum pump 16 as a power pump. Motor 56 may drive vacuum pump 16 using a hydraulic system. Other types of power transfer systems are possible, including belt and direct drive systems.

Referring to FIG. 14, vacuum pump 16 may be operably connected to be driven by engine 20 of loader 12. In this configuration, vacuum pump 16 may be connected to engine 20 via a direct drive system with an electric clutch. The electric clutch can be engaged by flipping a switch within cab 22 of loader 12. Various drive connections may be used, including a belt drive system or a hydraulic system. The direct drive system is preferred because it is a simpler design, easier to maintain, and doesn't involve complex hydraulic components. Vacuum pump 16 in this configuration does not require motor 56. Mounting vacuum pump 16 at the back of loader 12, as shown in FIG. 14, is advantageous for the purpose of coupling to a rear-mounted engine. This provides for a much more compact, balanced system.

Referring to FIGS. 1 and 14, vacuum pump 16 may be mounted on a platform 58 supported by loader 12. It may be possible for loader 12 to install vacuum pump 16 by backing up and winching platform 58 into place at the rear of loader 12. Vacuum pump 16 may be mounted on any part of loader 12, for example the frame of loader 12. Referring to FIG. 6, vacuum pump 16 may be mounted on a trailer 60. Vacuum pump 16 may be mounted on any type of mobile or stationary platform that is not supported by loader 12. Referring to FIG. 14, another configuration of vacuum pump 16 is shown.

Referring to FIG. 1, a hydro excavation assembly 62 may be provided as part of excavation apparatus 10. Hydro excavation assembly 62 may comprise a water tank 64, a water pump 66, a hose 68, a wand 70, and a motor 72. A water heater (not shown) may be added to hydro excavation assembly 62 in order to prevent the water used in hydro excavation assembly 62 from freezing when used in cold environments. Water pump 66 is connected to pump water from water tank 64 to wand 70 through hose 68. Wand 70 may be operated by hand, or may be operated mechanically by a machine. Wand 70 aids in aiming the spray of water during an excavation, although wand 70 is not required. Wand 70 may be provided as part of, or operated by, loader 12. An example of this type of operation is to have wand 70 linked to vacuum hose 18. Wand 70 may be provided as part of an additional lifting arm (not shown) on loader 12. Motor 72 is operably connected to drive water pump 66. Motor 72 may be for example a diesel engine.

Referring to FIG. 1, hydro-excavation assembly 62 may be provided as any type of high-pressure fluid pump that is capable of dislodging solid materials. As an example, hydro excavation assembly 62 may be an air pressure excavation assembly. A trailer 63 may be used to carry hydro-excavation assembly 62. Trailer 63 may be pulled by loader 12 or a separate vehicle (not shown). Trailer 63 may be connected to loader 12 by a tow bar and hitch assembly 64. Any part or all parts of hydro-excavation assembly 62 may be provided attached to, or as part of, loader 12. Referring to FIG. 6, an example of this is shown with hydro-excavation assembly 62 being located on a platform 74 supported by loader 12. In this example, water pump 66 may be connected to be driven by engine 20 of loader 12.

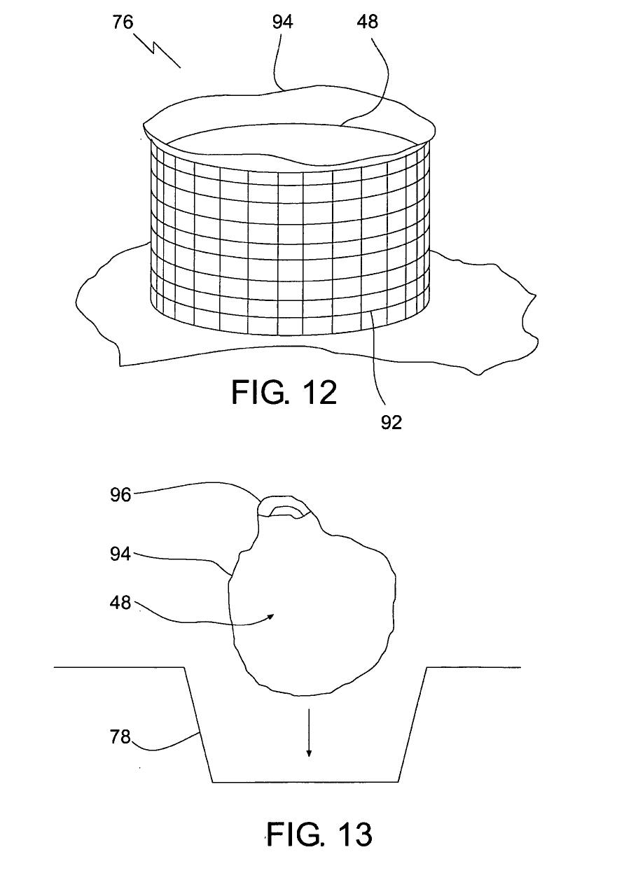

Referring to FIG. 3, a container 76 can be used to receive dumped contents of tank 14. Referring to FIG. 12, container 76 may be a mesh container permeable to liquids but impermeable to solids above a selected size. The mesh container may for example be a wire support 92 and a liner 94. Liner 94 may be provided as a bag, or as a single sheet of material. Referring to FIG. 13, liner 94 may be constructed of biodegradable material, such that slurry of solids and water 48 may be dumped along with liner 94. Liner 94 may be disposed of in hole 78 by lifting by a strap 96 and dumping, as shown. Container 76 may be placed in hole 78 and wire support 92 removed, allowing liner 94 and slurry 48 to spread out into hole 78. Because liner 94 is biodegradable, liner 94 can be buried with slurry 48. Liner 94 may be a cloth liner, for example made of burlap.

Referring to FIG. 12, wire support 92 may be a coarse grade of wire mesh. The wire support 92 of the mesh container may be for example a wire basket or a wire mesh rolled into an open-ended cylinder. An example of container 76 may be a wire basket capable of holding from one to ten cubic yards of soil. By using a mesh container permeable to liquids, liquids contained within the material dumped from tank 14 into container 76 are allowed to drain from container 76. Container 76 may in other embodiments be any suitable container capable of holding solids and water, and may be impermeable to water. Container 76 may be carried on a platform or trailer (not shown), or provided as a stand-alone unit. In another embodiment, container 76 may be mounted on the back of a truck. Referring to FIG. 4, container 76 may be used to dump any material contained within container 76. This may be accomplished by manipulation from loader 12, or by manipulation from a separate piece of machinery or device, such as a dump truck.

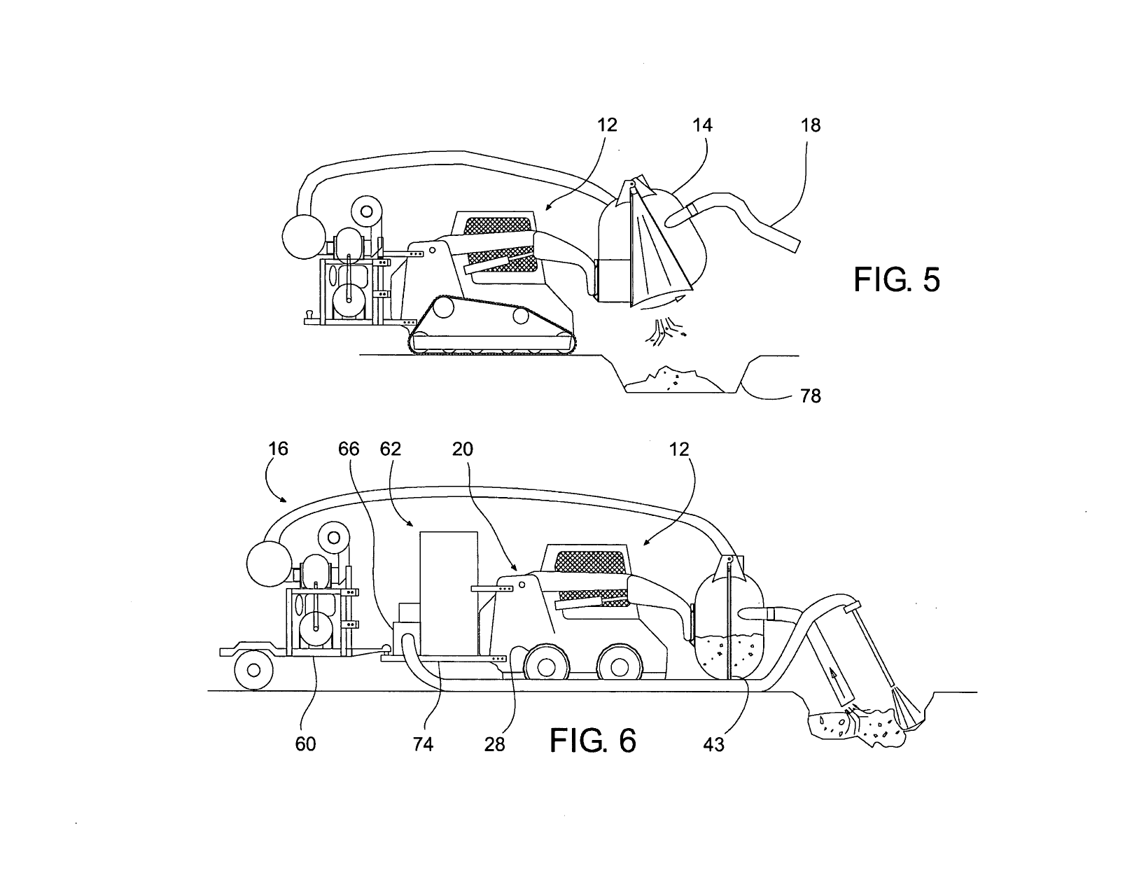

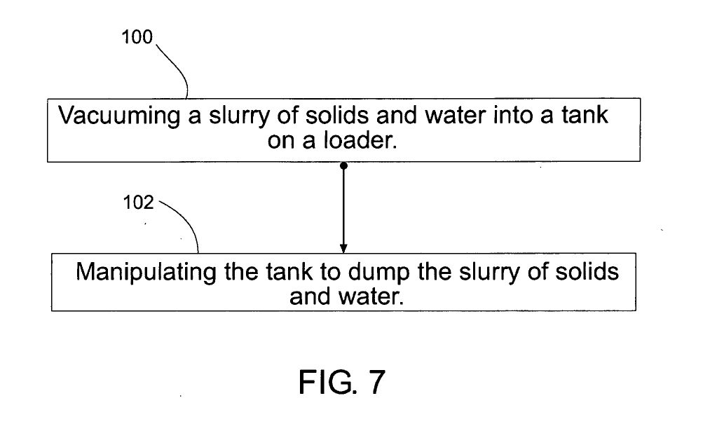

In operation, excavation apparatus 10 operates using methods such as illustrated in FIGS. 7-11. It should be understood that any method of operation described herein can be applied using any of the examples of excavation apparatus disclosed. Referring to FIG. 7 a general method of excavation is disclosed. In step 100, slurry of solids and water 48 are vacuumed into tank 14 of loader 12, as shown in FIG. 1. Tank 14 may be attached to lifting arm 24. Slurry 48 is vacuumed up from hole 78. Hole 78 may be a trench or tunnel, or any other type of excavation site. Slurry 48 may have been created by loosening ground material with water from wand 70 prior to or during vacuuming. Slurry 48 may be vacuumed up by slowly lowering tank 14 such that the end of vacuum hose 18 is always positioned underneath the level of slurry 48, until slurry 48 has been removed from hole 78, or tank 14 is full. If hole 78 is very deep, a longer vacuum hose 18 may be attached to excavation inlet 32. In some embodiments, hose 18 may be twelve to fourteen feet long. In some embodiments, hose 18 may be manually operated by a worker, or operated by a separate arm attached to loader 12. In some embodiments, remote control may be used to operate hose 18, loader 12, or wand 70. In step 102, tank 14 is manipulated by loader 12 to dump slurry of solids and water 48 from tank 14. Manipulating tank 14 may be accomplished by operating the lifting arm. Referring to FIG. 5, step 102 is shown as loader 12 is dumping slurry 48 into hole 78. In some embodiments, loader 12 may dump the contents of tank 14 at any appropriate location. In some embodiments, loader 12 may only dump the solids, or the liquids, contained in tank 14. Referring to FIG. 3, loader 12 may dump slurry 48 into container 76.

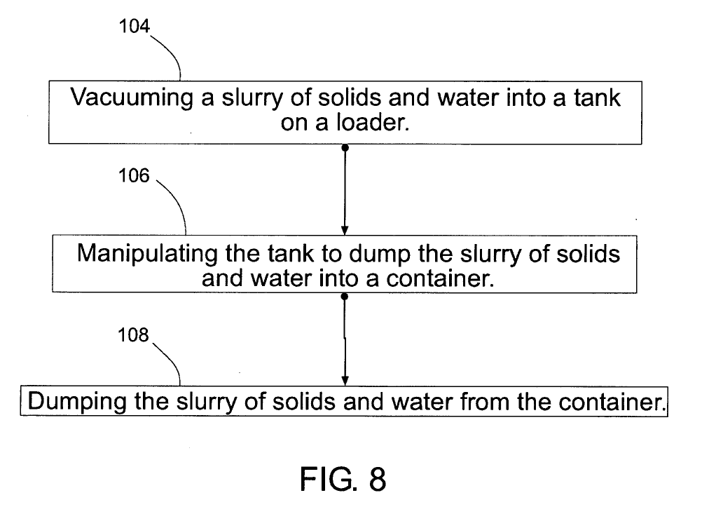

Referring to FIG. 8, in step 104, slurry of solids and water 48 are vacuumed up from hole 78 as in step 100. In step 106, however, tank 14 is manipulated by loader 12 to dump slurry of solids and water 48 from tank 14 into container 76. Referring to FIG. 3, this is shown. As with step 102, loader 12 may only dump the solids, or the liquids, contained in tank 14 into container 76. Referring to FIG. 2, the liquids may be decanted from the settled solids in tank 14 prior to dumping into container 76 (shown in FIG. 12). Referring to FIG. 12, slurry 48 may be allowed to sit within container 76, allowing liquid to drain through the permeable mesh container. Additionally, liquid may evaporate from slurry 48 while contained within container 76. In step 108, the contents of container 76 are dumped. An example of step 108 is shown in FIGS. 4 and 13, where slurry 48 deposited by tank 14 is dumped into hole 78. In some embodiments, only the solids or the liquids from slurry 48 may be dumped from container 76. In some embodiments, container 76 may dump its contents at any appropriate location other than hole 78. Container 76 may be dumped by manipulation from loader 12, for example by hooking container 76 to lifting arm 24 and lifting and dumping container 76. In some embodiments, liner 94 can be lifted by loader 12 by hooking strap 96 to lifting arm 24 and dumping liner 94 containing slurry 48 into hole 78. Tank 14 may be removed from lifting arm 24 prior to lifting container 76 or liner 94.

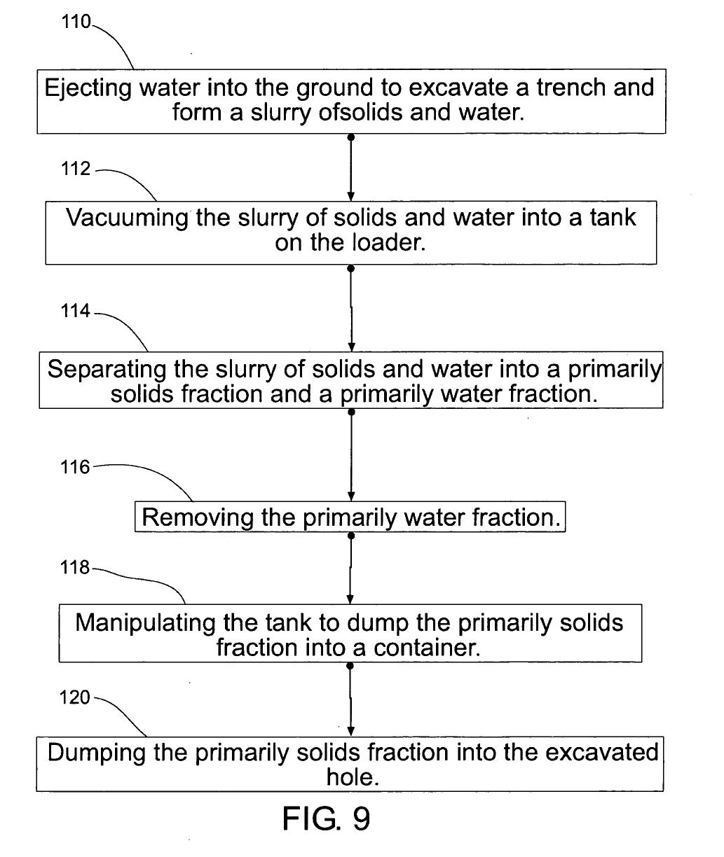

Referring to FIG. 9, in step 110, the slurry of solids and water 48 is formed by ejecting water into the ground to excavate a trench or hole. Examples of possible excavation applications may include an open pit excavation, excavating a trench around an existing pipeline, fibre optic line, or wireline, a power pole insertion, or any type of excavation. The advantage of using a hydro-excavation is that sensitive buried components, such as cables or pipelines, are prevented from being damaged during excavation. A traditional excavation using digging tools may damage such sensitive buried components. In step 112, slurry 48 is vacuumed up into tank 14 using vacuum hose 18 as described previously. In step 114, slurry 48 is separated into a primarily solids fraction 98 and a primarily water fraction 99. Referring to FIG. 2, primarily solids fraction 98 has settled out of primarily water fraction 99. In step 116, primarily water fraction 99 is removed from slurry 48. This may be accomplished by decanting off water fraction 99 as shown, or by pumping or draining off water fraction 99. Other methods of removing water fraction 99 may be used. Solids fraction 98 may be removed instead. Step 116 may not be necessary. In step 118, primary solids fraction 98 is dumped into container 76 via manipulation of tank 14. Referring to FIG. 3, this is accomplished by lifting tank 14 with lifting arm 24, and opening tank 14. Upon the emptying of tank 14, the inside of tank 14 may be cleaned. Referring to FIG. 14, cleaning tank 80 upon emptying is accomplished more easily than cleaning tank 14 due to the shorter height of tank 80 and the wider opening created by opening tank 80. In step 120, primarily solids fraction 98 is dumped from container 76 into hole 78. Step 120 may be carried out in a manner similar to that described above for step 108 above.

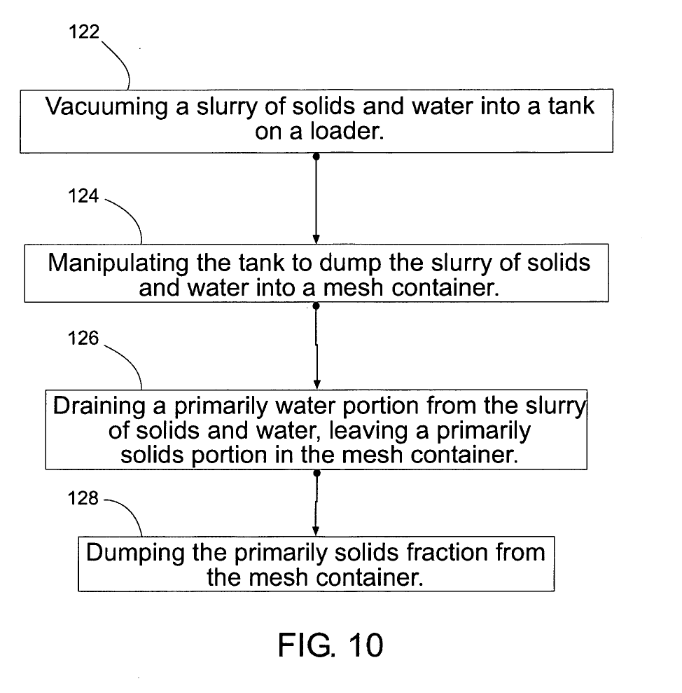

Referring to FIG. 10, in step 122 slurry 48 is vacuumed into tank 14. In step 124, tank 14 is manipulated by loader 12 to dump slurry 48 into container 76, which is a mesh container, as shown in FIG. 12. In step 126, primarily water fraction 99 is drained from slurry 48, leaving primarily solids fraction 98. This may be accomplished by leaving slurry 48 to sit within container 76, which allows liquid to drain through the permeable mesh container. Liquid may evaporate from slurry 48 while contained within container 76. Additional loads of slurry 48 may be dumped into container 76 during this time. In step 128, the contents of container 76 are dumped. The contents of container 76 may be dumped according to the methods described above for step 108.

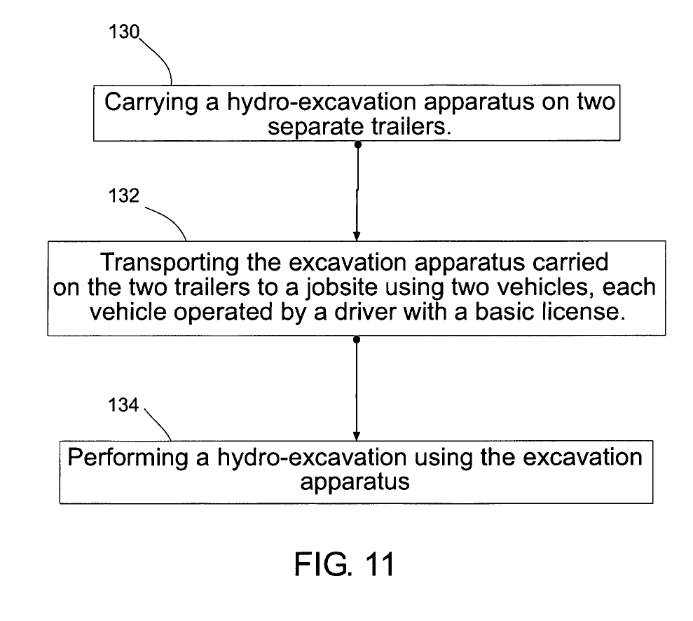

Referring to FIG. 11, in step 130, excavation apparatus 10 is carried on two separate towing trailers to a jobsite. Typical towing trailers used in this operation are roughly twenty four to twenty eight feet in length, although other lengths are possible. Alternatively, additional towing trailers may be employed. Hydro excavation assembly 62 may be loaded onto one of the towing trailers, with loader 12 loaded onto the other towing trailer. Hydro excavation assembly 62 may be carried on trailer 63, trailer 63 being carried on one of the tow trailers. Trailer 63 may be provided as one of the tow trailers. Additional equipment may also be carried on either or both of the tow trailers, such as extra water tanks. By having an extra water tank carried on each of the towing trailers, 1900-2500 gallons of water can be transported to a jobsite for use in a hydro-excavation. In general, the tow trailer carrying hydro excavation assembly 62 should be covered, or contained within a compartment, which may be heated. This helps prevent hydro excavation assembly 62 from freezing when being transported in colder temperatures. In step 132, the two tow trailers carrying excavation apparatus 10 are transported to the jobsite. The advantage of placing loader 12 and hydro excavation assembly 62 on separate tow trailers is that the two tow trailers can be transported using vehicles that can be operated with a basic license. An example of such a vehicle may include a one-ton truck, or a light or medium-duty 4500-5500 series truck. If loader 12 and hydro excavation assembly 62 are carried on the same tow trailer, then their weight may exceed the restrictions imposed on towing with these types of vehicles. Using these types of vehicles cuts down on labor costs by lowering the operation requirements of users of excavation apparatus 10. The operators of these vehicles can then operate excavation apparatus 10 upon arriving at the jobsite. In step 134, excavation apparatus 10 is used to carry out a hydro-excavation. An example of the above described method would involve transporting excavation apparatus 10 to the jobsite as described in step 130, each vehicle being operated by an operator.

Upon reaching the jobsite, one operator will begin hydro excavating a location on the site. In the meantime, the other operator may unload loader 12, and set up container 76 in a location where water drained from container 76 will not have any adverse or unwanted effects on the location. An example of a suitable location for container 76 may include a dirt field where no local wildlife or plants will be affected. Loader 12 may not have tank 14 installed on lifting arm 24 yet, and may assist the first operator in hydro excavating by using loader 12 to manually loosen dirt with traditional tools that may be installed on lifting arm 24. Examples of these tools may be augers, buckets, or other digging devices. When the second operator is ready to vacuum up slurry 48 created by the first operator during the hydro excavation, he installs tank 14 on lifting arm 24 (if tank 24 is currently uninstalled), and begins vacuuming up slurry 48. Upon completely vacuuming up slurry 48, or filling tank 14, the second operator drives loader 12 to container 76 where slurry 48 is dumped into. At this point, tank 14 may be cleaned to remove caked on mud from slurry 48. Upon emptying slurry 48 into container 76, loader 12 may resume vacuuming up slurry 48 from the hydro excavation, and dumping loads of slurry 48 into container 76. Upon completion of the hydro excavation, any work necessary to be accomplished prior to backfilling hole 78 may be done, such as installing or repairing existing piping. Loader 12 may then be used to dump container 76 back into hole 78 created from the hydro excavation. This may be accomplished by lifting liner 94 by strap 96, and placing liner 94 into hole 78.

Upon completing the hydro excavation, excavation apparatus 10 is loaded up on the tow trailers and transported from the jobsite in the same manner as it was transported to the jobsite. This type of method allows the same type of hydro excavation to be carried out as could be carried out by a traditional hydrovac truck, albeit with the advantages that it may now be done in a remote location, and in a faster, cheaper, and more efficient manner. Additionally, excavation apparatus 10, when fully loaded onto the tow trailers with extra water tanks can carry more water than a traditional hydrovac truck, and operate with the same level of performance.

Depending on the work being done, various liners or bags may be used to contain the materials vacuumed up during the job. The liner or bag may be impermeable to water and solids so as to completely retain the slurry dumped into the liner or bag. In some applications, water may be allowed to drain from the liner or bag prior to dumping of the slurry. Thus, for example when digging a pipeline, the system may use a burlap bag so water wicks out and the mud stays contained and can be put back in the hole or ditch that has been dug. Burlap is biodegradable so it can easily be pushed back in the hole with the mud. In the case of a communications line, smaller bags may be used, which may be dumped back into the hole dug, or dumped into a hole at another location nearby, or removed for disposal at a remote location, for example using a small trailer carrying the bags. In the example of performing maintenance work in a city, evacuated slurry or mud may be dumped into a container that can be hauled away by cheaper equipment, or the mud may be placed in sealed bags that can then be dumped in a land fill, or dumped into small mud trailers for removal, or dumped into trucks such as gravel trucks that haul it away. The proposed equipment is well suited for work within cities with a small maneuverable unit and multiple dumping options such as those described.

The loader may be equipped with a vacuum bar supporting the vacuum hose on the front and a filter bag house trailer to allow vacuuming up of dry materials in and around power generating stations, conveying plants, grain elevators, loading terminals, etc. The loader can be lifted to roof tops that are being redone and it can suck up the gravel on the roofs and dump it in piles so the tar can be redone. The loader can be used on construction sites to suck up water, spills, dig holes. The loader can be loaded on boats to clean up debris. The loader can be helicoptered, as a whole unit, or in parts, into locations that big trucks can not get into.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims. Immaterial modifications may be made to the embodiments described here without departing from what is claimed.

What is claimed is:

1. An excavation apparatus, comprising:
a loader having a lifting arm and tracks or wheels;
a tank having a containing wall, in which at least a portion of the containing wall defines a dump door, and wherein the tank is attached to the lifting arm of the loader;
a vacuum pump in fluid connection with the tank; and
a vacuum hose in fluid connection with the tank.

2. The excavation apparatus of claim 1 in which the vacuum pump is mounted on a platform supported by the loader.

3. The excavation apparatus of a claim 1 further comprising:
a water tank, a water pump, and a water hose, the water pump being connected to pump water from the water tank to water hose.

4. The excavation apparatus of claim 3 further comprising a trailer connected by a tow bar and hitch to the loader, the trailer carrying the water tank, the water pump and the water hose.

5. The excavation apparatus of any claim 1 in which the loader has a turning radius less than the length of the loader.

6. The excavation apparatus of claim 1 in which the loader is mounted on individually reversible tracks or individually reversible wheel pairs.

7. The excavation apparatus of claim 1 in which the tank has a clamshell configuration.

8. The excavation apparatus of claim 1 in which the loader is an all-terrain vehicle or tractor.

9. The excavation apparatus of claim 1 in which the loader is a commercially available loader retrofitted with the vacuum pump and the tank.

10. The excavation apparatus of claim 1 in which the tank is hingedly attached to the lifting arm for dumping.

11. The excavation apparatus of claim 1 in which the at least a portion of the containing wall is hinged, slideable or removable.

12. The excavation apparatus of claim 1 in which the vacuum pump is mounted at the back of the loader.

13. A method of excavation, comprising the steps of:
vacuuming a slurry of solids and water from a hole or trench at an excavation site into a tank mounted on a lifting arm of a loader; and
manipulating the tank by operating the lifting arm to dump the slurry of solids and water from the tank through a dump door on the tank.

14. The method of claim 13 further comprising, prior to the step of vacuuming the slurry of solids and water into the tank, ejecting water into a ground surface from a water pump to excavate the hole or trench, and form the slurry of solids and water.

15. The method of claim 13 in which manipulating the tank to dump the slurry of solids and water comprises emptying the tank into a container.

16. The method of claim 13 further comprising the step of separating the slurry of solids and water into a primarily solids fraction and a primarily water fraction.

17. The method of claim 16 in which the primarily water fraction is disposed of separately at the excavation site.

18. The method of claim 16 further comprising the step of returning at least a part of the primarily solids fraction to the hole or trench to refill the hole or trench.

19. The method of claim 18 in which at least a part of the primarily solids fraction is returned to the hole or trench by manipulation of the tank.

20. The method of claim 14 further comprising the steps of:
transporting the water pump on a first trailer to the excavation site; and
transporting the loader on a second trailer to the excavation site.

21. The method of claim 20 in which transporting the first trailer comprises carrying the first trailer on a third trailer.

22. The method of claim 15 in which the container comprises a wire support and a liner.

23. The method of claim 22 in which the liner is constructed of biodegradable material.

24. The method of claim 13 in which the slurry of solids and water are dumped into the trench or hole.

25. A method of earth working, the method comprising the steps of:
vacuuming a slurry of solids and water from a first location on the surface of the earth;
transferring the slurry of solids and water to a container comprising a support and a liner; and
dumping the liner and at least a portion of the slurry of solids and water back into the first location on the surface of the earth or into a hole formed at a second location in the earth.

26. The method of claim 25 in which the support comprises a wire mesh.

27. The method of claim 25 wherein the liner is a bag constructed of biodegradable material.

28. The method of claim 26 further comprising the step of allowing at least a part of the water from the mixture of solids and water to drain or evaporate while in the liner.

29. The method of claim 25 wherein the slurry of solids and water are provided from a hydro-excavation.

30. The method of claim 25 in which the liner and at least a portion of the slurry of solids and water is dumped back into the first location on the surface of the earth.

31. The method of claim 25 in which the liner and at least a portion of the slurry of solids and water is dumped into a hole formed at a second location in the earth.
